(19) United States
(12) Patent Application Publication
(10) Pub. No.: US 2016/0371578 A1
(43) Pub. Date: Dec. 22, 2016

(54) GASKET WITH TWO-DIMENSION CODE

(71) Applicant: YanTai Hicap Closures Ltd., Yantai City (CN)

(72) Inventor: RUIYUAN SUN, Yantai City (CN)

(21) Appl. No.: 15/187,212

(22) Filed: Jun. 20, 2016

(30) Foreign Application Priority Data
Jun. 19, 2015 (CN) 201520431481.1

(51) Int. Cl. G06K 19/06; F16J 15/02

(52) U.S. Cl. CPC G06K 19/06037; F16J 15/022

(57) ABSTRACT

A gasket with two-dimension code of the present invention comprises a substrate, a two-dimension code, and a film. The two-dimension code is located between the substrate and the film, and the said two-dimension code is associated with a computer recognition system. The gasket with two-dimension code of the present invention generally is provided in a bottle cap of a bottle body for use, and comprises a substrate, a two-dimension code, and a film. The two-dimension code is located between the substrate and the film. The gasket with two-dimension code of the present invention is marked on the gasket by a printing device, and a film is covered on the surface of the two-dimension code. The film is used to protect the two-dimension code from easily being erased or damaged, in order to be easily read by a reading device.

### TECHNICAL FIELD

The present invention relates to an anti-counterfeiting gasket for goods, more particularly relates to an anti-counterfeiting gasket for a bottle cap.

### BACKGROUND ART

In modern society, the counterfeiting of goods has increasingly become a serious problem in global economy domain, which not only has greatly damaged the vital benefits of the manufacturers and the vast number of consumers, and disrupted the market order, but also has brought some very bad impacts on the brand building and maintenance of social stability. The application of digital anti-fake system can a certain extent prevent and reduce the occurrence of the phenomenon of fake and shoddy goods. For example, an anti-counterfeiting code is generally attached to goods, but the anti-counterfeiting code is exposed outside and is easy to be imitated. If it is sprayed inside the goods, which may pollute the packaging and contaminate the goods itself, it would cause the damages to human body.

### DISCLOSURE OF THE TECHNICAL SOLUTION

The aim of the present invention is: solving the above technical problems that there are in current anti-counterfeiting of goods, and providing such a gasket with two-dimension code that it is used in goods anti-counterfeiting, and it is difficult for faking, and safe and reliable.

To achieve the object of the present invention, the technical solution of the present invention is as follows.

The gasket with two-dimension code of the present invention comprises a substrate, a two-dimension code, and a film. The said two-dimension code is located between the substrate and the film, and associated with a computer recognition system.

A surface of the said gasket of the present invention with the two-dimension code is opposite to an opening of a bottle cap.

The two-dimension code of the present invention is sprayed on the said substrate or film.

The said gasket of the present invention is formed with a substrate, a two-dimension code, and a film in sequence.

The said film of the present invention comprises an inner film and an outer film. The said gasket is formed with a substrate, an inner film, a two-dimension code, and an outer film in sequence.

The said film of the present invention comprises a bottom film and an outer film. The said gasket is formed with a bottom film, a substrate, a two-dimension code, and an outer film in sequence.

The said film of the present invention comprises a bottom film, an inner film and an outer film. The said gasket is formed with a bottom film, a substrate, an inner film, a two-dimension code, and an outer film in sequence.

The difference between the gasket with two-dimension code of the present invention and the prior art is: the gasket with two-dimension code of the present embodiment comprises a substrate, a two-dimension code, and a film, the two-dimension code is located between the substrate and the film, the two-dimension code is marked on the gasket by a printing device, and a film is covered on the surface of the two-dimension code. The film is used to protect the two-dimension code from easily being erased or damaged, and is in order to be easily read by a reading device. In addition, jet ink generally contains a variety of chemical components, such as ketones, resins, dyes etc. If jet ink of the two-dimension code is directly contacted with packaging, it will not only pollute the packaging, but also may cause the damages to the human body. The covering film blocks the ink from directly contacting with the packaging, so as to effectively improve the food safety and sanitation grade of the packaging materials.

### BRIEF DESCRIPTION OF THE DRAWINGS

FIG. 1 is a whole structural perspective view of the gasket with two-dimension code of the present invention.

FIG. 2 is a structural perspective view of the first embodiment of the gasket with two-dimension code of the present invention.

FIG. 3 is a structural perspective view of the second embodiment of the gasket with two-dimension code of the present invention.

FIG. 4 is a structural perspective view of the third embodiment of the gasket with two-dimension code of the present invention.

FIG. 5 is a structural perspective view of the fourth embodiment of the gasket with two-dimension code of the present invention.

### DETAIL DESCRIPTION OF PREFERRED EMBODIMENTS

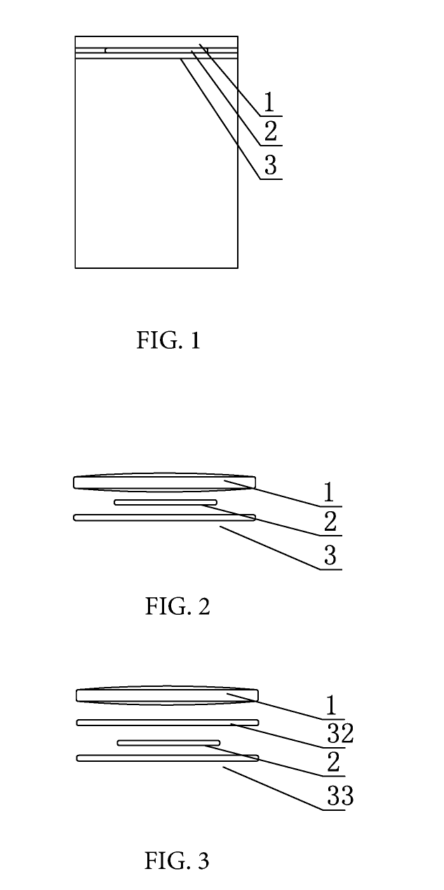

As shown as FIG. 1, the gasket with two-dimension code 2 of the present embodiment generally is provided in a bottle cap of a bottle body for use, and comprises a substrate 1, a two-dimension code 2, and a film 3. The two-dimension code 2 is located between the substrate 1 and the film 3. The two-dimension code 2 of the gasket of the present invention is marked on the gasket by a printing device, and a film 3 is covered on the surface of the two-dimension code. The film 3 is used to protect the two-dimension code 2 from easily being erased or damaged, and in order to be easily read by a reading device. In addition, jet ink generally contains a variety of chemical components, such as ketones, resins, dyes etc. If jet ink of the two-dimension code 2 is directly contacted with packaging, it will not only pollute the packaging, but also may cause the damages to the human body. The covering film blocks the ink of the two-dimension code 2 from directly contacting with the packaging, so as to effectively improve the food safety and sanitation grade of the packaging materials.

The two-dimension code 2 of the present invention is sprayed on the substrate 1 or the film 3. After being sprayed, the two-dimension code 2 is located in an interlayer between the substrate 1 and the film 3. A surface of the said gasket with the two-dimension code is opposite to an opening of a bottle cap. When it is applied, there are some following embodiments.

As shown as FIG. 2, the said gasket is formed with a substrate 1, a two-dimension code 2, and a film 3 in sequence.

As shown as FIG. 3, the said film comprises an inner film 32 and an outer film 33. The said gasket is formed with a substrate 1, an inner film 32, a two-dimension code 2, and an outer film 33 in sequence.

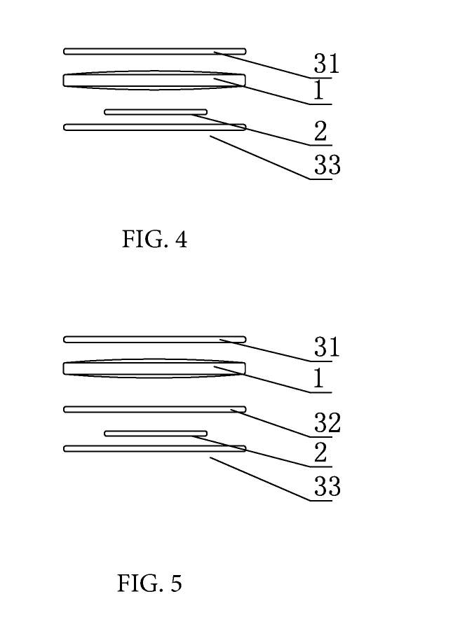

As shown as FIG. 4, the said film comprises a bottom film 31 and an outer film 33. The said gasket is formed with a bottom film 31, a substrate 1, a two-dimension code 2, and an outer film 33 in sequence.

As shown as FIG. 5, the said film comprises a bottom film 31, an inner film 32 and an outer film 33. The said gasket is formed with a bottom film 31, a substrate 1, an inner film 32, a two-dimension code 2, and an outer film 33 in sequence.

If a company wants to fake the bottle and opened a bottle cap to get a two-dimension code 2 on a gasket, for one code corresponding to one cap, it would lose effect after inquiry once, and it can't be applied on other faked wine products, which can play a role in anti-counterfeiting. Specific design methods are as follows.

(1) A gasket is provided by a company of making bottle caps, and product information is provided by a gasket custom manufacturer to the company of making bottle caps.

(2) A two-dimension code 2 for anti-counterfeiting is made by the company of making bottle caps, an only anti-counterfeiting code (that is a character string) is given to every product before product information comes in network. The anti-counterfeiting code comprises number 0-9 or its combination with some letters of the alphabets. Then the anti-counterfeiting code is changed and combined again according to an encoding rule of a computer recognition system to create a disorder code. The obtained disorder code is a two-dimension code 2 for anti-counterfeiting. It is very difficult for a company who want to counterfeit to fake to decode the two-dimension code 2, and products of the gasket custom manufacturer can't be copied in large quantities.

(3) The company of making bottle caps makes a computer recognition system. Then an anti-counterfeiting code is input to a computer recognition system and only corresponding to a product.

(4) A two-dimension code 2 is marked on a gasket according to the above embodiment, finishing the production of a gasket with two-dimension code 2.

The method of anti-counterfeiting inquiry for the above gasket with two-dimension code 2 is:

A two-dimension code 2 is scanned by a mobile phone or a scanner. Then it is transferred to a computer recognition system by internet. A computer recognition system computes an anti-counterfeiting code by a special algorithm according to the two-dimension code 2, then compares with the corresponding anti-counterfeiting code of every product input when registered on internet. If it is matched, then callout the corresponding audio files, and answer: “the product that you queried is XX product produced by XX factory, expiration date is Year XX, is a genuine product”. At the same time, the queried information is recorded by the computer recognition system. If it is not matched, then a voice system prompts to input again and a voice answers: “the number you entered is not correct, beware of faking.” If an anti-counterfeiting code after compared is found that it has been entered, then a system answers: “the number you entered has been entered on X Year X Month X Day, and cancelled, beware of faking.”

When a company wanted to fake the bottle and opened a bottle cap to get a two-dimension code 2, the company generally queried whether a product relative to a two-dimension code 2 is a genuine product. As every product of the present invention corresponds to only one anti-counterfeiting code, information on true or false can't be obtained again after once query, and a computer recognition system answers: “the number you entered has been entered on X Year X Month X Day, and cancelled, beware of faking.” If a two-dimensional code 2 for anti-counterfeiting stolen by a company is copied on large quantities of bottle caps of faked wine, then only one product can be genuine. When the other faked products are queried, the computer recognition system answers: “the number you entered has been entered on X Year X Month X Day, and cancelled, beware of faking.” Therefore, as long as faked one product, it would need to buy one genuine product, which raise the cost of faking of a company.

Although explanatory embodiments have been shown and described, it would be appreciated by those skilled in the art that changes, alternatives, and modifications can be made in the embodiments without departing from spirit and principles of the invention. Such changes, alternatives, and modifications all fall into the scope of the claims and their equivalents.

1. A gasket with two-dimension code, characterized by: comprises a substrate, a two-dimension code, and a film, the said two-dimension code is located between the substrate and the film, and the said two-dimension code is associated with a computer recognition system.

2. The gasket with two-dimension code according to claim 1, characterized by: a surface of the said gasket with the two-dimension code is opposite to an opening of a bottle cap.

3. The gasket with two-dimension code according to claim 2, characterized by: the two-dimension code is sprayed on the said substrate or the film.

4. The gasket with two-dimension code according to claim 2, characterized by: the said gasket is formed with a substrate, a two-dimension code, and a film in sequence.

5. The gasket with two-dimension code according to claim 2, characterized by: the said film comprises an inner film and an outer film, and the said gasket is formed with a substrate, an inner film, a two-dimension code, and an outer film in sequence.

6. The gasket with two-dimension code according to claim 2, characterized by: the said film comprises a bottom film and an outer film, and the said gasket is formed with a bottom film, a substrate, a two-dimension code, and an outer film in sequence.

7. The gasket with two-dimension code according to claim 2, characterized by: the said film comprises a bottom film, an inner film and an outer film, and the said gasket is formed with a bottom film, a substrate, an inner film, a two-dimension code, and an outer film in sequence.
